(19) United States
(12) Patent Application Publication
(10) Pub. No.: US 2025/0211004 A1
(43) Pub. Date: Jun. 26, 2025

(54) OPEN CIRCUIT AND BACK-SURGE PROTECTION FOR POWER SUPPLIES

(71) Applicant: Advanced Energy Industries, Inc., Denver, CO (US)

(72) Inventor: Brendan Barry, Cork (IE)

(21) Appl. No.: 18/392,169

(22) Filed: Dec. 21, 2023

(51) Int. Cl. H02J 7/00; H02J 7/04; H02J 7/34

(52) U.S. Cl. CPC H02J 7/0034; H02J 7/0047; H02J 7/04; H02J 7/345; H02J 2207/20

(57) ABSTRACT

This disclosure describes systems, methods, and apparatuses for open-circuit and back-surge protection of power supplies, where the method comprises: generating a voltage at an output of a power supply; monitoring a rate of change of the voltage with a detection-protection circuit, the detection-protection circuit comprising a capacitor and a plurality of resistors having different resistance values; in response to the rate of change of the voltage exceeding a threshold, discontinuing the generation of the voltage to protect the power supply; and preventing a back bias into at least a portion of the detection-protection circuit, wherein the preventing the back bias is based at least on a respective resistance value of each of the plurality of resistors.

### FIELD OF THE DISCLOSURE

The present disclosure relates generally to power supplies. Specifically, but without limitation, the present disclosure relates to systems, methods, and apparatuses for open circuit and/or back-surge protection of power supplies.

### DESCRIPTION OF RELATED ART

Some power supplies, such as, but not limited to, switch-mode power supplies (SMPS′) are employed to efficiently transform voltage and current from one form to another (e.g., Alternating Current (AC) to Direct Current (DC), DC to AC, or DC-DC). In some cases, SMPS′ may utilize energy storage elements (e.g., capacitors and/or inductors) to store energy during one part of a high-frequency switching cycle, and release said energy during another part of the high-frequency switching cycle. In some cases, such power supplies can also be referred to as “capacitor chargers” as they can be employed to charge one or capacitors coupled at the output of the power supply. Furthermore, the capacitor(s) charged using such capacitor chargers can be subsequently discharged to release a large amount of energy in a short duration, which can be used to power lasers (e.g., in medical applications, such as tattoos or hair removal).

In some cases, an SMPS (e.g., capacitor charger) may be utilized to supply the required voltage and current to a bank of ‘large’ capacitors. These capacitors may be electrically connected to a laser via one or more semiconductor switches, such as, but not limited to, a Metal-oxide Semiconductor Field Effect Transistor (MOSFET) or Insulated-gate Bipolar Transistor (IGBT). This allows the laser to generate a powerful pulse of light (i.e., a high-energy laser beam), which can then be focused on a target area (e.g., a patch of hair for hair removal, a tattoo for tattoo removal, to name two non-limiting examples).

Ideally, capacitor chargers should be designed to charge the output capacitors within a reasonable amount of time and in a consistent manner (e.g., minimal to no overshoots). In some circumstances, adequate design of capacitor chargers can prove to be difficult. Some of the major difficulties experienced by designers include developing an adequate protection system for protecting the power supply (or capacitor charger) against undesired open circuit conditions, as well as protecting it against minimum capacitance to ensure over-voltages do not occur. Currently used techniques for protecting power supplies, such as capacitor chargers, are lacking in several regards. For example, while some protection systems do exist for protecting against over-voltage conditions, they inadvertently limit the charging speed, which adversely impacts user experience. In other cases, a capacitance is added before the output terminals of the capacitor charger to protect against over-voltage conditions. This, however, can cause dangerous resonant currents to circulate in the system. Additionally, the capacitors (e.g., film capacitors) added at the output of the power supply tend to be bulky and/or susceptible to failure when over-voltage conditions do occur.

Thus, there is a need for a refined method and system for protecting power supplies (e.g., capacitor chargers) that can help enhance power supply performance, as compared to the prior art.

The description provided in the description of related art section should not be assumed to be prior art merely because it is mentioned in or associated with this section. The description of related art section may include information that describes one or more aspects of the subject technology.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Aspects of the present disclosure generally relate to systems, methods, and apparatuses for protecting power supplies (e.g., switch-mode power supplies, such as capacitor chargers). More specifically, but without limitation, the present disclosure relates to systems, methods, and apparatuses for open circuit and/or back-surge (or back bias) protection for power supplies. In some cases, aspects of the present disclosure can help protect the power supply (e.g., capacitor charger) and output circuitry (e.g., pulsed laser system) from over-voltages due to open-circuit faults, without sacrificing power supply performance with regards to charging speed, charging consistency (e.g., minimal to no overshoots), user safety, system size, and/or system complexity, to name a few non-limiting examples.

In some aspects, the techniques described herein relate to a method for protecting a power supply, including: generating a voltage at an output of the power supply; monitoring a rate of change of the voltage with a detection-protection circuit, the detection-protection circuit including a capacitor and a plurality of resistors having different resistance values; in response to the rate of change of the voltage exceeding a threshold, discontinuing the generation of the voltage to protect the power supply; and preventing a back bias into at least a portion of the detection-protection circuit, wherein the preventing the back bias is based at least on a respective resistance value of each of the plurality of resistors.

In some aspects, the techniques described herein relate to a method, wherein the detection-protection circuit includes: a resistor-capacitor circuit having the capacitor (e.g., C_{dvdt} in FIG. 4) and a first resistor (e.g., R_{discharge}) arranged in series; a diode (e.g., D₅); and a second resistor (e.g., R_{dvdt}), wherein the first resistor has a higher resistance value than the second resistor; and wherein the method further includes: preventing damage to the resistor-capacitor circuit, based in part on the diode preventing high frequency harmonics from entering the capacitor of the resistor-capacitor circuit.

In some aspects, the techniques described herein relate to a method, wherein the higher resistance value of the first resistor as compared to the second resistor enables: reducing an amount of current flowing through the capacitor of the resistor-capacitor circuit; and limiting the voltage at the output of the power supply during an open-circuit fault, based at least in part on the reducing the amount of current flowing through the capacitor.

In some aspects, the techniques described herein relate to a method, wherein the method further includes: providing a current path through the capacitor and a diode of the detection-protection circuit for one or more of limiting the voltage during an open-circuit fault and reducing the rate of change of the voltage; and discharging the capacitor through the first resistor.

In some aspects, the techniques described herein relate to a method, wherein one or more of: a resistance value of the first resistor is at least 500 times greater than a resistance value of the second resistor; and the power supply includes a capacitor charger. In some other cases, the resistance value of the first resistor may be around 1000 times greater than a resistance value of the second resistor.

In some aspects, the techniques described herein relate to a method, wherein the generating the voltage at the output of the power supply further includes: applying an alternating current (AC) waveform at an input of the power supply; and rectifying the AC waveform to produce a rectified direct current (DC) waveform with an AC component at the output of the power supply.

In some aspects, the techniques described herein relate to a method, wherein the generating the voltage at the output of the power supply further includes applying a direct current (DC) waveform at an input of the power supply.

In some aspects, the techniques described herein relate to a method, wherein the method further includes: minimizing or reducing a false detection of an open-circuit fault at the output of the power supply by slowing down or reducing the rate of change of the voltage.

In some aspects, the techniques described herein relate to a method, wherein discontinuing the generation of the voltage is based at least in part on detecting an open-circuit fault at the output of the power supply.

In some aspects, the techniques described herein relate to a power supply including: an input end configured for coupling to a power source; a plurality of output terminals configured for coupling to a load; a detection-protection circuit including: a resistor-capacitor circuit having a capacitor and a first resistor, and a back bias prevention circuit having at least a second resistor, wherein the back bias prevention circuit is configured to prevent a back bias into the capacitor of the resistor-capacitor circuit based at least in part on the first and second resistors having different resistance values; and one or more processing devices configured to: monitor a voltage across the plurality of output terminals using the detection-protection circuit; and disable the power source responsive to the monitored voltage reaching a threshold.

In some aspects, the techniques described herein relate to a power supply, wherein, the resistor-capacitor circuit includes the capacitor arranged in series with the first resistor; and the back bias prevention circuit further includes a diode, wherein a first end of the diode is coupled between the capacitor and the first resistor, and wherein a second end of the diode is coupled to a first end of the second resistor and a comparator.

In some aspects, the techniques described herein relate to a power supply, wherein the comparator is configured to compare a rate of change of the monitored voltage to a trip level or the threshold.

In some aspects, the techniques described herein relate to a power supply, wherein the first resistor has a higher resistance value than the second resistor, thereby, reducing an amount of current flowing through the resistor-capacitor circuit; and limiting a voltage across the output terminals of the power supply during an open-circuit fault.

In some aspects, the techniques described herein relate to a power supply, further including a path for current to flow from the capacitor, and through the diode and the second resistor for one or more of: limiting the voltage across the output terminals of the power supply during the open-circuit fault; and reducing the rate of change of the voltage.

In some aspects, the techniques described herein relate to a power supply, wherein the back bias prevention circuit is configured to minimize or reduce a likelihood of a false detection of an open-circuit fault across the output terminals of the power supply by slowing down or reducing the rate of change of the voltage.

In some aspects, the techniques described herein relate to a power supply, wherein disabling the power source is based at least in part on detecting an open-circuit fault across the output terminals of the power supply.

In some aspects, the techniques described herein relate to a power supply, further including: a rectifier circuit coupled to the input end and configured to receive an alternating current (AC) waveform from the power source and provide a rectified direct current (DC) waveform with an AC component at the output terminals of the power supply.

In some aspects, the techniques described herein relate to a power supply, wherein the power source includes a direct current (DC) power source.

In some aspects, the techniques described herein relate to an open-circuit and back-surge protection system for power supplies, including: a detection-protection circuit, the detection-protection circuit coupled between an input end and an output end of a power supply, the detection-protection circuit including: a resistor-capacitor circuit having a capacitor and a first resistor arranged in series; and a back bias prevention circuit having at least a second resistor, wherein the back bias prevention circuit is configured to prevent a back bias into the capacitor of the resistor-capacitor circuit, based at least in part on the first and second resistors having different resistance values; and one or more processing devices configured to: monitor, using the detection-protection circuit, a rate of change of a voltage at the output end of the power supply; and in response to the rate of change of the voltage exceeding a threshold, discontinue the generation of the voltage to protect the power supply.

In some aspects, the techniques described herein relate to an open-circuit and back-surge protection system, wherein: the back bias prevention circuit further includes a diode, wherein a first end of the diode is coupled between the capacitor and the first resistor, and wherein a second end of the diode is coupled to a first end of the second resistor and a comparator; and a resistance value of the first resistor is at least 500 times greater than a resistance value of the second resistor.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a’, ‘an’, and ‘the’ include plural referents unless the context clearly dictates otherwise.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates a block diagram of a power supply having a protection circuit, according to various aspects of the disclosure.

FIG. 2 illustrates another block diagram of a power supply having a protection circuit, and a load coupled at the output of the power supply, according to various aspects of the disclosure.

FIG. 3 illustrates a schematic diagram of a power supply having a protection circuit, and a load coupled at the output of the power supply, according to various aspects of the disclosure.

FIG. 4 illustrates another schematic diagram of a power supply having a detection-protection circuit, and a load circuit coupled at the output of the power supply, according to various aspects of the disclosure.

FIG. 5 illustrates another schematic diagram of a power supply having a detection-protection circuit, and a load circuit coupled at the output of the power supply, according to various aspects of the disclosure.

FIG. 6 illustrates an example of a load circuit, such as a laser treatment system, coupled at an output of a power supply, according to various aspects of the disclosure.

FIG. 7 illustrates an example of a controller comprising a comparator, where the controller can be utilized with any of the power supplies described with reference to FIGS. 1 through 6, according to various aspects of the disclosure.

FIG. 8 illustrates a conceptual graph showing a comparison of the output voltage against time for a prior art power supply and the disclosed power supply, according to various aspects of the present disclosure.

FIG. 9 illustrates an example of a method for protecting a power supply, according to various aspects of the present disclosure.

FIG. 10 illustrates a block diagram of a computer system that can be used to effectuate one or more aspects of the present disclosure.

### DETAILED DESCRIPTION

Prior to describing the embodiments in detail, it is expedient to define certain terms as used in this disclosure.

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the functionality and operation of possible implementations of a power supply having a protection system for open-circuit and/or back-surge protection of the power supply, according to various embodiments of the present disclosure. In some instances, the open-circuit and back-surge protection system may comprise one or more of a controller, a comparator, a detection circuit, and/or a protection circuit, in accordance with one or more implementations. It should be noted that, in some alternative implementations, the functions noted in each block may occur out of the order noted in the figures. For example, two blocks shown in succession may, in fact, be executed substantially concurrently, or the blocks may sometimes be executed in the reverse order, depending upon the functionality involved.

As used herein, the terms “power supply”, “capacitor charger”, “switch-mode power supply”, and “power system” may be used interchangeably throughout the disclosure.

As noted earlier, switch-mode power supplies (SMPS′) are employed to efficiently transform voltage and current from one mode/form to another (e.g., Alternating Current (AC) to Direct Current (DC), DC to AC, or DC-DC). In some cases, SMPS′ may utilize energy storage elements (e.g., capacitors and/or inductors) to store energy during one part of a high-frequency switching cycle, and release said energy during another part of the high-frequency switching cycle. In some cases, such power supplies can also be referred to as “capacitor chargers” as they can be utilized to charge one or capacitors coupled at the output of the power supply. Furthermore, the capacitor(s) charged using such capacitor chargers can be subsequently discharged to release a large amount of energy in a short duration, which can be used to power lasers (e.g., in medical applications, such as tattoos or hair removal).

Ideally, such power supplies (e.g., capacitor chargers) should be designed to charge the output capacitors within a reasonable amount of time and in a consistent manner (e.g., minimal to no overshoots). In some circumstances, adequate design of capacitor chargers can prove to be difficult. Some of the major difficulties experienced by designers include developing an adequate protection system for protecting the power supply (or capacitor charger) against undesired open circuit conditions, as well as protecting it against over-voltage conditions (e.g., due to minimum or no capacitance at the output end of the power supply). Currently used techniques for protecting power supplies, such as capacitor chargers, are lacking in several regards. For example, while some protection systems do exist for protecting against over-voltage conditions, they inadvertently limit the charging speed, which adversely impacts user experience. In other cases, a capacitance is added before the output terminals of the capacitor charger to protect against over-voltage conditions. This, however, can cause dangerous resonant currents to circulate in the system.

Broadly, aspects of the present disclosure are directed to systems, methods, apparatuses, and/or storage media configured for open-circuit and back-surge protection of power supplies, which can help enhance power supply performance, as compared to the prior art.

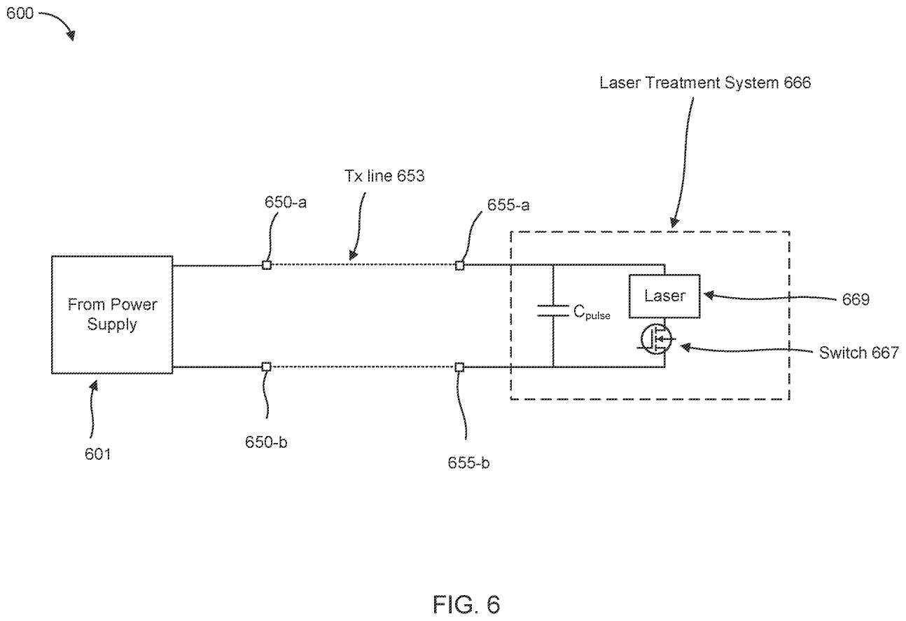

In some cases, the power supply described herein can comprise a capacitor charger that can be utilized for laser driving applications. For example, the power supply can be coupled to a load circuit, where the load circuit includes a capacitor (e.g., Cₚᵤₗₛₑ in FIG. 6) and a pulsed laser system (e.g., laser 669 coupled to switch 667). In some cases, the power supply can be used to charge the load capacitor. Furthermore, the load capacitor can be discharged to power the pulsed laser system. While not necessary, in some examples, the pulsed laser system may be used for medical applications, such as hair or tattoo removal. Other use cases besides medical application are also contemplated in different embodiments and the examples listed herein are not intended to limit the scope and/or spirit of the present disclosure.

In some circumstances, a power supply (or capacitor charger) can inadvertently disconnect from the load circuit, for instance, due to a break or fault in the transmission line connecting the two. This can lead to an open-circuit fault in the system, which may result in over-voltage conditions at the output end of the power supply. Oftentimes, over-voltages due to open-circuit faults can be very damaging (e.g., to the internal circuitry of the power supply) and even dangerous/hazardous to the end-user. To mitigate against these issues, some aspects of the present disclosure are directed to a power supply having an open-circuit and back-surge protection system that can help protect the user and the power supply from over-voltages resulting from open-circuit faults.

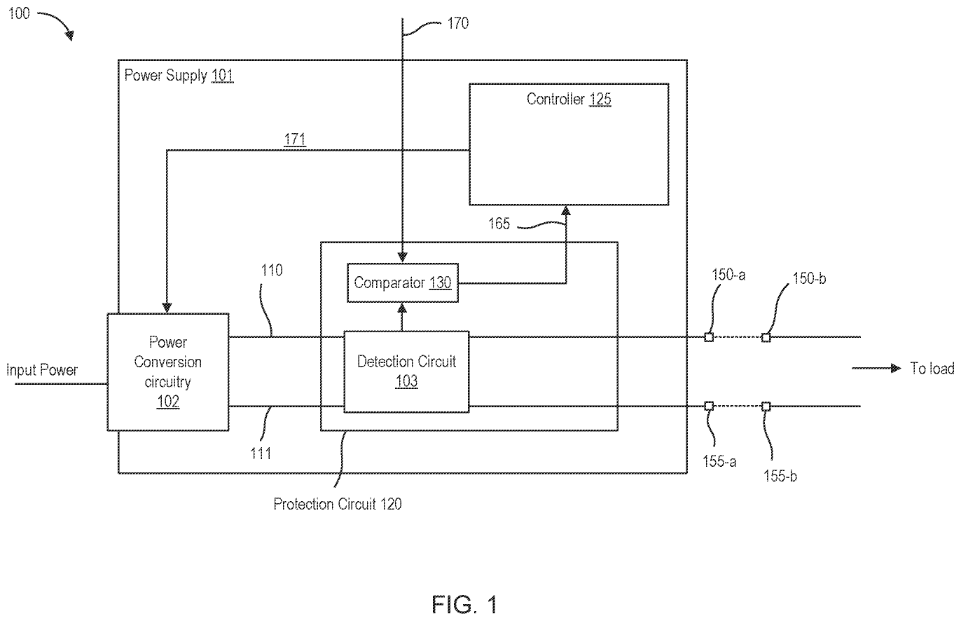

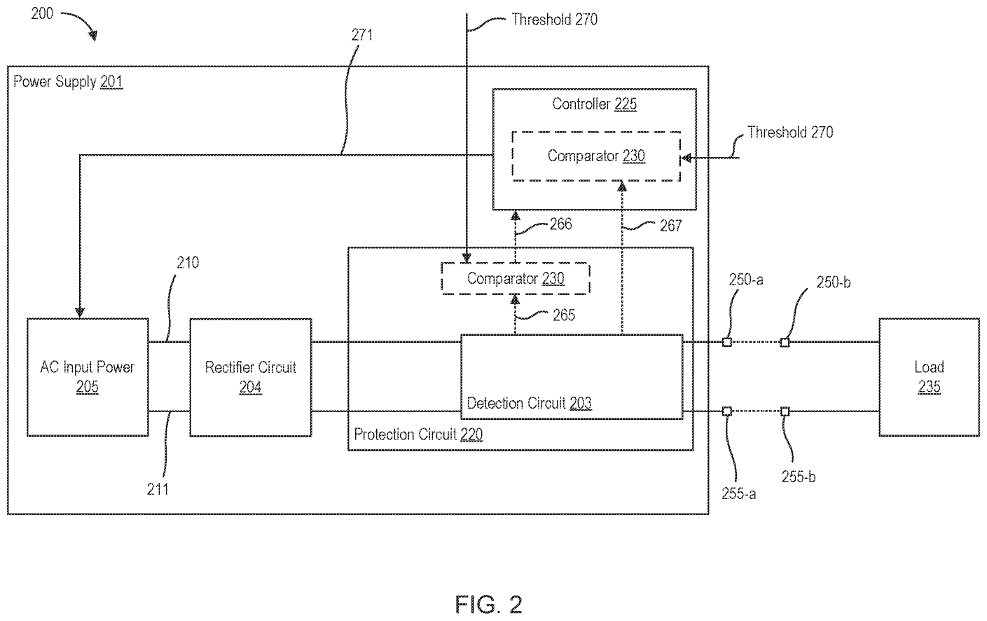

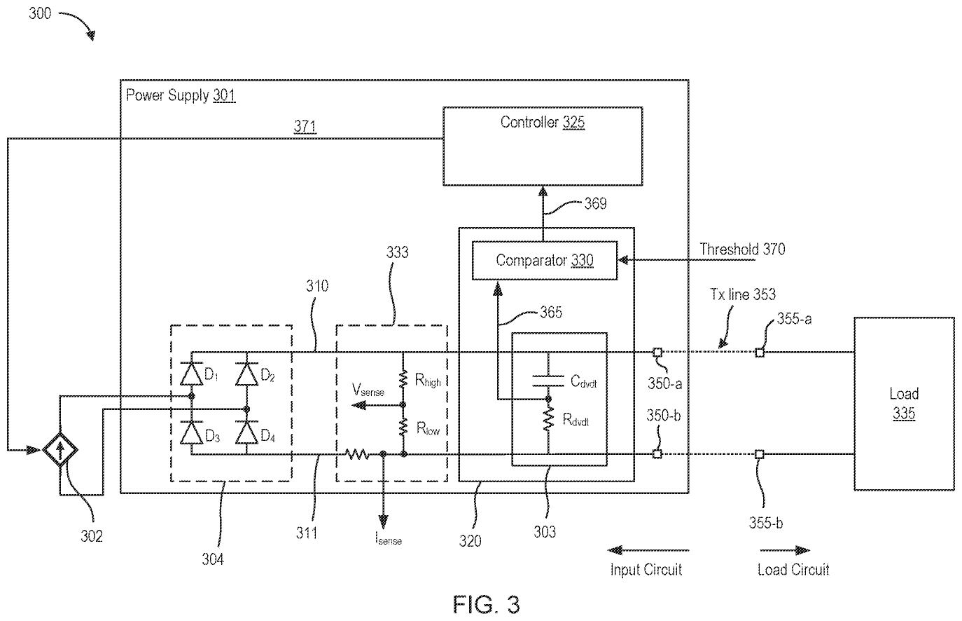

Turning now to FIG. 1, which illustrates an example of a system 100 configured for open-circuit and back-surge protection of power supplies, according to various aspects of the disclosure. As seen, the system 100 comprises a power supply 101 coupled to a load (e.g., shown as load 235 in FIG. 2) using a transmission line (e.g., transmission line 353 in FIG. 3). The power supply 101 comprises power conversion circuitry 102 (e.g., AC-DC conversion circuit, DC-DC conversion circuit), a protection circuit 120, and a controller 125. The protection circuit 120 can further include a detection circuit 103 and a comparator 130. The power supply 101 can include two power rails 110 and 111, where power rail 110 may be associated with a higher voltage level than the power rail 111. In some cases, the protection circuit 120 can be electrically coupled between the power conversion circuitry 102 and the output end of the power supply. The output end can include two nodes (e.g., node 150-a, node 155-a), as shown in FIG. 1. Furthermore, each of the output nodes 150-a, 155-a can be configured to be electrically coupled to a node (e.g., node 150-b, node 155-b) at an input end of the load, for instance, using a transmission line. In this example, the nodes 150-a and 150-b can be electrically coupled using a transmission line, while nodes 155-a and 155-b can be electrically coupled using another transmission line.

In some embodiments, the input power may comprise an alternating current (AC) source and the power conversion circuitry 102 can comprise a rectifier (e.g., half or full-bridge rectifier). This helps generate a voltage (e.g., DC voltage) at an output of the power supply 101, which can then be used to power the load circuit, charge a capacitor (if any) in the load circuit, etc. In some cases, the detection circuit 103 may be configured to monitor a rate of change of the voltage and provide information related to this monitored voltage to the comparator 130. The comparator 130 may receive an indication of at least one threshold 170 from an external source (not shown), where the at least one threshold 170 may correspond to a threshold rate of change and/or a threshold voltage. In some cases, for instance, due to an open-circuit fault at the output end of the power supply, the output voltage can rise rapidly. Furthermore, the voltage at the output of the power supply can also increase to very high levels (e.g., >1 kV, >3 kV, etc.). Besides being dangerous to the end-user, such over-voltage conditions can also have detrimental effects on the internal circuitry (e.g., diodes of the rectifier circuit) of the power supply 101 if they are not designed to handle such high voltage and/or high current levels.

In some embodiments, the protection circuit 120 and controller 125 can help mitigate the effects of such open-circuit faults and/or over-voltage conditions by quickly identifying when an open-circuit condition occurs and discontinuing the generation of the output voltage to protect the power supply 101 and the end-user. In some cases, the detection circuit 103 provides information related to one or more of the output voltage and the rate of change of the output voltage to the comparator 170. In one non-limiting example, the comparator 130 compares the rate of change of the output voltage to a pre-defined threshold (e.g., threshold 170) and determines whether the rate of change of the monitored output voltage exceeds the threshold 170. In some cases, the comparator 130 outputs a signal 165 to the controller 125, e.g., in response to determining that the rate of change of the output voltage exceeds the threshold. In such cases, the controller 125 outputs a control signal 171 to the power conversion circuitry 102 to discontinue the generation of the output voltage to protect the power supply 101.

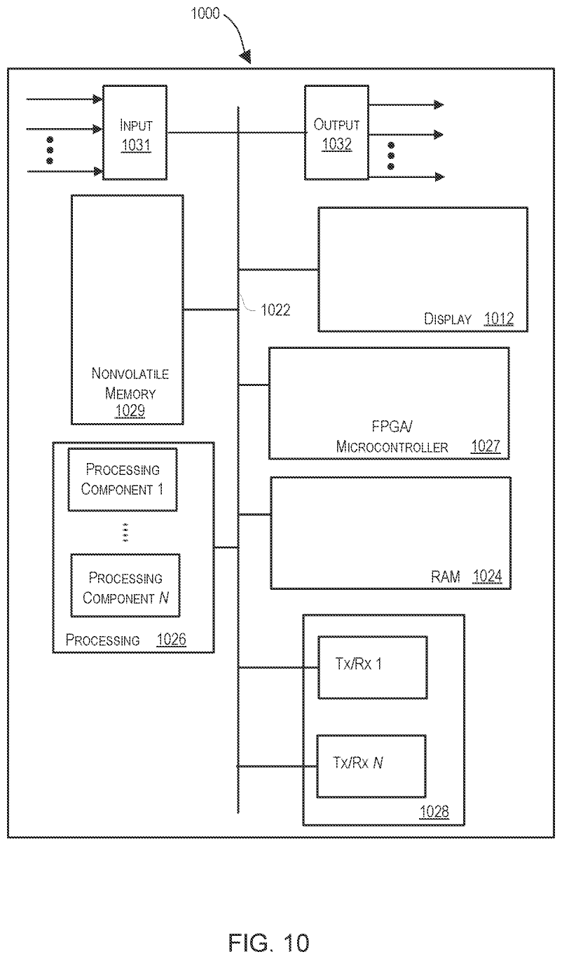

FIG. 2 illustrates another block diagram of a system 200, according to various aspects of the disclosure. In some examples, the system 200 may implement one or more aspects of the system 100 and/or any of the other power systems described herein. As seen in FIG. 2, the system 200 comprises a power supply 201 having an AC input power source 205, a first power rail 210, a second power rail 211, a rectifier circuit 204, a protection circuit 220, and a controller 225. The protection circuit 220 may be similar or substantially similar to the protection circuit 120 described with reference to FIG. 1. As seen, the protection circuit 220 includes a detection circuit 203 and an optional comparator 230. Alternatively, the comparator 230 can be implemented within the controller 225. In either case, the comparator 230 may be configured to receive an indication of a threshold 270 (e.g., threshold related to a rate of change of output voltage), where the threshold 270 may be indicated by a user or another external source. In one non-limiting example, the input component 1031 (i.e., in FIG. 10) may receive an indication of the threshold(s) 170 and/or 270.

Similar to FIG. 1, the power supply 201 can include a plurality of nodes 250-a, 255-a at the output end of the power supply, where each of the nodes 250-a and 255-a is configured to be electrically coupled to one of nodes 250-b and 255-b at the input end of the load 235. In this example, the node 250-a (or output terminal 250-a) can be electrically coupled to the node 250-b of the load 235 using a first transmission line segment, while the node 255-a (or output terminal 255-a) can be electrically coupled to the node 255-b of the load 235 using a second transmission line segment. FIG. 3 depicts these first and second transmission line segments as transmission line (or Tx line) 353.

FIG. 3 illustrates a schematic diagram of a system 300 configured for open-circuit and back-surge protection of power supplies, according to various aspects of the disclosure. As seen, the system 300 comprises a power supply 301, the power supply 301 having a power conversion circuit 304 (e.g., a full-bridge rectifier having diodes D₁, D₂, D₃, and D₄), a monitoring circuit 333, and a protection circuit 320. The input end of the power supply 301 may be coupled to an AC source 302 (e.g., a current source). Additionally, the output end of the power supply 301 may include a plurality of nodes (or terminals), such as output node 350-a and output node 350-b. In some embodiments, the output end of the power supply 301 may be configured to couple to a load circuit (e.g., load 335) using the Tx line 353. Specifically, the Tx line 353 may be used to couple the output nodes 350-a and 350-b to the input nodes 355-a and 355-b, respectively, of the load 335. In some cases, the power supply 301 may include two power/voltage rails 310 and 311, where one of the rails (e.g., rail 310) may be at a higher voltage with respect to ground and/or the other rail (e.g., rail 311).

In some cases, the current source 302 may be configured to apply an AC waveform at the input of the power supply 301. Further, the AC waveform may be rectified by the rectifier circuit 304 to produce a rectified DC waveform with an optional AC component (e.g., high frequency harmonics if the power supply does not include a filter) at the output of the power supply 301. As shown in FIG. 3, the protection circuit 320 can include a detection circuit 303 and a comparator 330, which may be similar or substantially to the ones described above with reference to FIGS. 1 and/or 2. In this case, the detection circuit 303 comprises a resistor-capacitor circuit having a capacitor (C_{dvdt}) and a resistor (R_{dvdt}) arranged in series. In some cases, the comparator 370 is configured to monitor a rate of change of the output voltage (i.e., across nodes/terminals 350-a and 350-b) using the detection circuit 303 and compare it to a threshold 370 to determine whether there is an open-circuit fault at the output of the power supply 301. Here, input signal 365 corresponds to the monitored rate of change of the output voltage, in which case threshold 370 also corresponds to a threshold rate of change. In some examples, the controller 325 is configured to output a control signal 371 to the AC source 302 to discontinue the generation of the output voltage, in response to determining that the monitored rate of change (365) exceeds the threshold 370. This can help protect the internal circuitry of the power supply 301, such as, but not limited to, the diodes D₁ through D₄ of the rectifier circuit 304. In some cases, the comparator 330 transmits an output signal 369 to the controller 325 to indicate whether the monitored rate of change of output voltage (365) exceeds the threshold 370. In some circumstances, there may be no open-circuit fault at the output end of the power supply 301, in which case the monitored rate may be lower than the threshold 370. In such cases, the comparator 369 can indicate (e.g., via output signal 369) that the threshold rate of change is not exceeded, in which case the controller 325 can refrain from transmitting the control signal 371 to the current source 302, or alternatively, transmit the control signal 371 to enable the current source 302 to continue supplying power to the power supply 301.

In some embodiments, one or more of the rectifier circuit 304 and the monitoring circuit 333 may be optional (shown as optional by the dashed lines). In one non-limiting example, a DC waveform may be applied at the input of the power supply 301, in which case no rectifier circuit 304 may be needed (or the rectifier circuit 304 may be optional).

In some aspects, the series resistor-capacitor circuit (i.e., comprising resistor (R_{dvdt}) and capacitor (C_{dvdt})) coupled across the output nodes/terminals of the power supply 301 can help detect when little to no capacitance (e.g., in the load 335) is connected to the power supply 301. As noted above, open-circuit faults can occur at the output of the power supply, e.g., due to a break or fault in the Tx line 353, disconnection of the Tx line from one or more of the terminals 350-a, 350-b, 355-a, and/or 355-b, to name two non-limiting examples. In some circumstances, the output voltage (i.e., across terminals 350-a and 350-b) may undergo a rapid rise when an open-circuit fault occurs in the system 300. Furthermore, a faster voltage rise can cause a decrease in the impedance provided by the capacitor (C_{dvdt}). In such cases, the voltage across the resistor (R_{dvdt}) plays a greater role in determining the voltage across the impedance divider network created by C_{dvdt} and R_{dvdt}. In other words, the comparator 330 (or alternatively, the controller 325) can detect a rapid rise in output voltage by monitoring the voltage across the resistor (R_{dvdt}). In some cases, the comparator 330 compares the rate of rise of the voltage (365) across the resistor (R_{dvdt}) and compares it to the threshold 370 to detect an open-circuit fault and/or overvoltage conditions. Such a design can help protect the diodes of the rectifier circuit 304 from over-voltages, which can allow for a more robust, reliable, and/or safer power system, as compared to the prior art. In some examples, the threshold 370 can correspond to a maximum ‘dv/dt’ of the output voltage and can be manually input by a designer or user of the system 300.

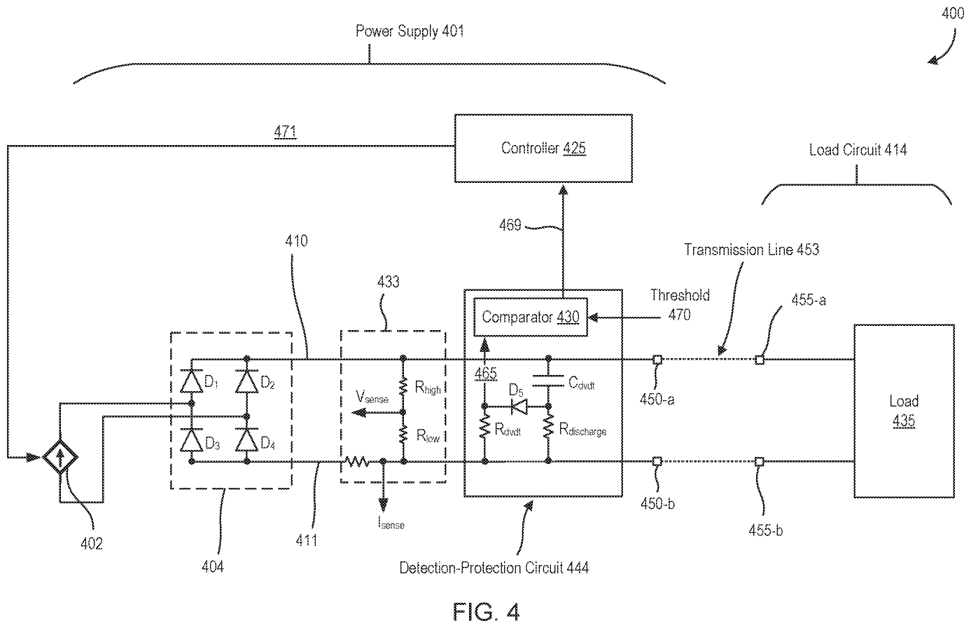

FIG. 4 illustrates another schematic diagram of a system 400 configured for open-circuit and back-surge protection of power supplies, according to various aspects of the disclosure. As seen, the system 400 comprises a power supply 401, the power supply 401 having an optional power conversion circuit 404 (e.g., a full-bridge rectifier having diodes D₁, D₂, D₃, and D₄), an optional monitoring circuit 433, and a detection-protection circuit 444. In some embodiments, the input end of the power supply 401 may be coupled to an AC source 402, such as a current source. Additionally, the output end of the power supply 401 may include a plurality of nodes (or terminals), such as output node 450-a and output node 450-b. In some embodiments, the output end of the power supply 401 may be configured to couple to a load circuit 414 using a Tx line 453. The load circuit 414 may include a load 435 (e.g., laser treatment system 666 in FIG. 6) and a plurality of input nodes 455-a, 455-b. As shown in FIG. 4, the Tx line 453 may be used to couple the output nodes 450-a and 450-b to the input nodes 455-a and 455-b, respectively, of the load circuit 414. In some cases, the power supply 401 may include two power/voltage rails 410 and 411, where one of the rails (e.g., rail 410) may be at a higher voltage with respect to ground and/or the other rail (e.g., rail 411).

In some cases, the AC source 402 (e.g., current source) may be configured to apply an AC waveform at the input of the power supply 401. Further, the AC waveform may be rectified by the rectifier circuit 404 to produce a rectified DC waveform with an optional AC component (e.g., high frequency AC harmonics) at the output of the power supply 401. In some embodiments, one or more of the rectifier circuit 404 and the monitoring circuit 433 may be optional (shown as optional by the dashed lines). In one non-limiting example, a DC waveform may be applied at the input of the power supply 401, in which case no rectifier circuit 404 may be needed.

As shown in FIG. 4, the detection-protection circuit 444 can include a comparator 430 and a resistor-capacitor circuit having a capacitor (C_{dvdt}) and a first resistor (R_{discharge}). In some cases, the detection-protection circuit 444 can further include a second resistor (R_{dvdt}), where the second resistor (R_{dvdt}) has a lower resistance value than the first resistor (R_{discharge}). In some non-limiting examples, the resistance value of the first resistor (R_{discharge}) may be at least 500 times or at least 1000 times greater than the resistance value of the second resistor (R_{dvdt}). For example, the resistance value of the first resistor (R_{discharge}) may be around 4.7 kΩ, while the resistance value of the second resistor (R_{dvdt}) may be around 4.7Ω. In one non-limiting example, the capacitor (C_{dvdt}) may have a capacitance value of around 1 μF. It should be noted that the resistance and capacitance values described above are exemplary only and not intended to limit the scope and/or spirit of the present disclosure. As seen in FIG. 4, the detection-protection circuit 444 may further include a diode (D₅), where a first end of the diode (D₅) is coupled between the capacitor (C_{dvdt}) and the first resistor (R_{discharge}). Additionally, a second end of the diode (D₅) is coupled to a first end of the second resistor (R_{dvdt}) and the comparator 430. In some instances, the second end of the second resistor (R_{dvdt}) is coupled to ground (or the low voltage rail 411).

In some cases, the comparator 430 is configured to monitor a rate of change of the output voltage (i.e., across nodes/terminals 450-a and 450-b) using the detection-protection circuit 444 and compare it to a threshold 470 to determine whether there is an open-circuit fault at the output of the power supply 401. Here, input signal 465 corresponds to the monitored rate of change of the output voltage, in which case threshold 470 also corresponds to a threshold rate of change. For instance, as noted above with reference to FIG. 3, the threshold 470 can correspond to a maximum ‘dv/dt’ of the output voltage and can be manually input by a designer or user of the system 400.

In some examples, the controller 425 is configured to output a control signal 471 to the current source 402 to discontinue the generation of the output voltage, where the discontinuing may be in response to determining that the monitored rate of change (465) exceeds the threshold 470. This can help protect the internal circuitry (e.g., diodes D₁ through D₄ of the rectifier circuit 404, resistor-capacitor circuit, etc.) of the power supply 401 from damage. In some cases, the diode (D₅) can also help prevent damage to the resistor-capacitor circuit (i.e., comprising C_{dvdt} and R_{discharge} arranged in series) by preventing high frequency harmonics (e.g., high frequency AC harmonics on the rectified DC waveform) into the capacitor (C_{dvdt}) of the resistor-capacitor circuit.

In some cases, the comparator 430 is configured to transmit an output signal 469 to the controller 425 to indicate whether the monitored rate of change of output voltage (465) exceeds the threshold 470. In some circumstances, there may be no open-circuit fault at the output end of the power supply 401, e.g., during normal operation of the system 400, in which case the monitored rate may be lower than the threshold 470. In such cases, the comparator 430 can indicate (e.g., via output signal 469) that the threshold rate of change is not exceeded, in which case the controller 425 can refrain from transmitting the control signal 471 to the AC source 402, or alternatively, transmit the control signal 471 to enable the AC source 402 to continue supplying power to the power supply 401.

In some aspects, the arrangement of one or more of the diode (D₅), capacitor (C_{dvdt}), and/or resistors (R_{dvdt}, R_{discharge}) of the detection-protection circuit 444 can help in one or more of protecting the power supply 401 during an open-circuit fault, limiting the output voltage during an open-circuit fault, reducing the rate of change of the output voltage to help prevent false detection of open circuit conditions, and/or preventing or reducing a back bias into at least a portion of the detection-protection circuit 444 to help prevent damage of the resistor-capacitor circuit. For example, the relative resistance values of the resistors, R_{dvdt} and R_{discharge}, can help prevent a back bias (e.g., from the load circuit 414) into at least a portion of the detection-protection circuit 444. Additionally, or alternatively, the resistance values of the resistors, R_{dvdt} and R_{discharge}, can help prevent the back bias by limiting a surge current coming back into the power supply 401. In some cases, this back bias may be a result of the capacitor in the load 435 not being fully discharged before reconnection of the load 435 to the power supply 401.

As noted above, in some examples, the resistance value of the second resistor (R_{dvdt}) may be lower than the resistance value of the first resistor (R_{discharge}). Such a design can help reduce the amount of current flowing through the capacitor (C_{dvdt}) of the resistor-capacitor circuit. Furthermore, reducing the amount of current flowing through the capacitor (C_{dvdt}) can assist in limiting the voltage at the output of the power supply 401, for instance, during an open circuit fault.

In some cases, the relative arrangement of the capacitor (C_{dvdt}) and the diode (D₅) can help provide a current path through the capacitor (C_{dvdt}) and the diode (D₅) of the detection-protection circuit 444, which can help in one or more of limiting the voltage during an open-circuit fault and/or reducing the rate of change of the output voltage across terminals 450-a and 450-b. During normal operation (e.g., no open-circuit fault), the diode D₅ may help prevent the capacitor (C_{dvdt}) from charging and discharging, meaning that the capacitor (C_{dvdt}) sees little to no harmonic content. However, during an open-circuit fault, the power supply 401 (or capacitor charger 401) may surge current through the capacitor (C_{dvdt}) and diode (D₅). In such cases, the capacitor (C_{dvdt}) may help slow down the rate of change (e.g., rise) of the output voltage, but provide little to no assistance with regards to the filtering of the output current. In some aspects, this diode (D₅) also helps prevent damage to the resistor-capacitor circuit by preventing high frequency harmonics from entering the capacitor (C_{dvdt}). Additionally, by selecting the resistance value of the first resistor (R_{discharge}) to be sufficiently high (e.g., >1 kΩ), a minimal amount of current flows through the capacitor (C_{dvdt}), i.e., since it is connected in series with the first resistor (R_{discharge}). In some aspects, a relatively high resistance value for the first resistor (R_{discharge}) helps provide a current path for the capacitor (C_{dvdt}) to discharge, e.g., in the event that an open-circuit fault occurs and the capacitor (C_{dvdt}) is partially or fully charged. Such a design helps prevent dangerously high voltages (e.g., few kV) from remaining at the output end of the power supply 401 as a result of an open-circuit fault, which helps enhance user safety. In some cases, the resistance value of the resistor (R_{dvdt}) is selected to be lower than the resistance value of the resistor (R_{discharge}), but still sufficiently high to reduce the surge current flowing through the diode (D₅) and thereby prevent damage to the diode (D₅), further described below.

In some circumstances, an end user may accidently reconnect the capacitor charger (or power supply 401) to the load circuit 414, which may cause a back surge of current (i.e., back bias) to flow from the load circuit 414 into the capacitor (C_{dvdt}) and the diode (D₅). In some aspects, the resistor (R_{dvdt}) can help limit this back surge of current, and thereby protect the diode (D₅) from being damaged. It should be noted that the resistance value of the second resistor (R_{dvdt}) can be selected to be high enough so that it helps limit this back surge of current, but low enough to ensure that the open-circuit ‘dv/dt’ does not rise too fast. In some instances, if the resistance value of the second resistor (R_{dvdt}) is too high, it may significantly impact the flow of current, which can cause the open-circuit ‘dv/dt’ to be too high (or fast). This can lead to a false detection of an open-circuit fault at the output of the power supply. Thus, there is a delicate balance that needs to be considered with regards to selecting the resistance values of the first resistor (R_{discharge}) and the second resistor (R_{dvdt}) of the detection-protection circuit 444. Appropriate selection of these resistance values can not only help reduce the amount of current flowing through the capacitor (C_{dvdt}) and limit the voltage at the output of the power supply, but also help reduce the rate of change of the output voltage and prevent damage to one or more components (e.g., diode D₅) of the detection-protection circuit 444. As indicated above, in some cases, the resistance value of the first resistor (R_{discharge}) may be on the order of kilo-ohms (e.g., >2 kΩ, around 4-5 kΩ, etc.), while the resistance value of the second resistor (R_{dvdt}) may be on the order of a few ohms (e.g., around 4-5Ω).

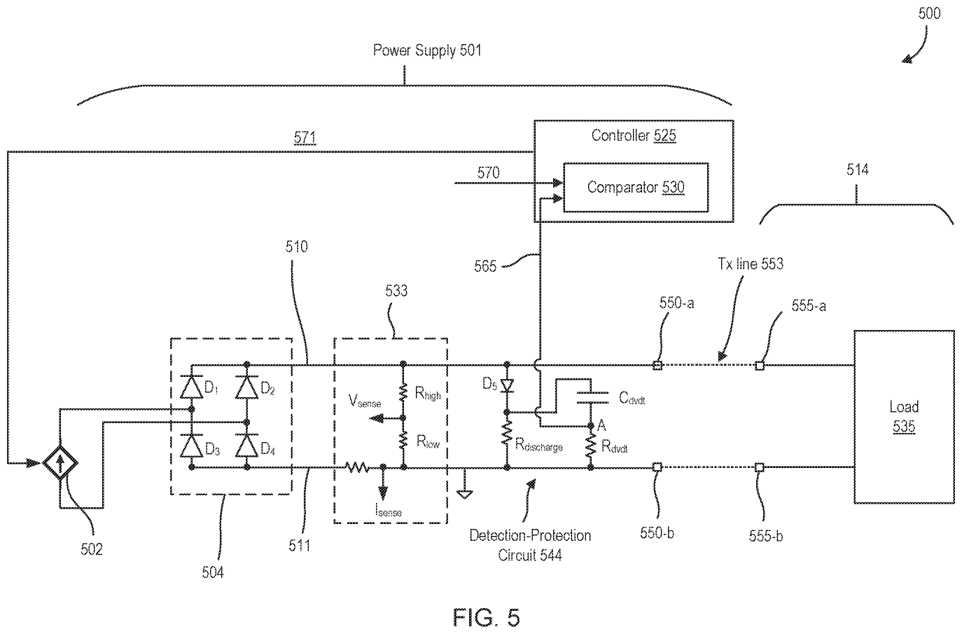

FIG. 5 illustrates another schematic diagram of a system 500 configured for open-circuit and back-surge protection of power supplies, according to various aspects of the disclosure. In this example, the system 500 comprises a power supply 501 having a detection-protection circuit 544, and a load circuit 535 coupled at the output of the power supply, in accordance with one or more implementations. In some examples, the power supply 501 may implement one or more aspects of the power supplies 301 and/or 401, previously described in relation to FIGS. 3 and/or 4. For example, one or more of the input source 502, power conversion circuit 504 (or rectifier circuit 404), monitoring circuit 533, controller 525, comparator 530, threshold 570, monitored signal 565, and/or control signal 571 may be similar or substantially similar to the ones described with reference to FIGS. 3 and/or 4.

Here, the power supply 501 includes an optional power conversion circuit 504 (e.g., a full-bridge rectifier having diodes D₁, D₂, D₃, and D₄), an optional monitoring circuit 533, and a detection-protection circuit 544. In some embodiments, the input end of the power supply 501 may be coupled to an AC source 502. Additionally, the output end of the power supply 501 may include a plurality of nodes (or terminals), such as output node 550-a and output node 550-b. In some embodiments, the output end of the power supply 501 may be configured to couple to a load circuit 514 using a Tx line 553. The load circuit 514 may include a load 535 and a plurality of input nodes 555-a, 555-b. As shown in FIG. 5, the Tx line 553 may be used to couple the output nodes 550-a and 550-b to the input nodes 555-a and 555-b, respectively, of the load circuit 514. In some cases, the power supply 501 may include two power/voltage rails 510 and 511, where one of the rails (e.g., rail 510) may be at a higher voltage with respect to ground and/or the other rail (e.g., rail 511).

In some cases, the AC source 502 (e.g., current source) may be configured to apply an AC waveform at the input of the power supply 501. Further, the AC waveform may be rectified by the rectifier circuit 504 to produce a rectified DC waveform with an optional AC component (e.g., high frequency AC harmonics) at the output of the power supply 501. In some embodiments, one or more of the rectifier circuit 504 and the monitoring circuit 533 may be optional (shown as optional by the dashed lines). In one non-limiting example, a DC waveform may be applied at the input of the power supply 501, in which case no rectifier circuit 504 may be needed.

FIG. 5 illustrates an alternate embodiment of the detection-protection circuit, in accordance with one or more implementations. In this example, a first end of the diode (D₅) is connected to the high voltage rail 510, while a second end of the diode (D₅) is coupled to one end of each of the resistor (R_{discharge}) and a capacitor (C_{dvdt}). Additionally, a second end of the first resistor (R_{discharge}) is coupled to ground or the low voltage rail 511. Similar to FIG. 4, the capacitor (C_{dvdt}) is arranged in series with a resistor (R_{dvdt}) to form a resistor-capacitor circuit. The second end of this resistor (R_{dvdt}) is also coupled to ground or the low voltage rail 511. In some examples, the resistance value of the first resistor (R_{discharge}) can be higher than the resistance value of the second resistor (R_{dvdt}).

As shown in FIG. 5, the comparator 530 is connected at a midpoint of the resistor-capacitor circuit, for instance, between the capacitor (C_{dvdt}) and the resistor (R_{dvdt}). The comparator 530 is configured to monitor a voltage at the output of the power supply 501 by monitoring the voltage at the terminal ‘A’ between the capacitor (C_{dvdt}) and the resistor (R_{dvdt}). In contrast to FIG. 4, where the diode (D₅) was not directly connected to either of the high voltage rail nor the low voltage rail, here one end of the diode (D₅) is connected to the high voltage rail 510. Additionally, in FIG. 5, one end of the capacitor (C_{dvdt}) is connected to the cathode of the diode (D₅), as opposed to the anode (e.g., in FIG. 4).

In some cases, the resistor (R_{dvdt}) may be optional, in which case its resistance value=0. In such cases, the detection-protection circuit 544 may comprise a resistor-capacitor-diode (RCD) snubber at the output of the power supply 501. While such a design may help protect the power supply 501 (or capacitor charger 501) from an open-circuit fault, it may provide minimal protection to the diode (D₅) from back-surge of current from the load circuit 514. For example, if the detection-protection circuit 544 does not include the resistor (R_{dvdt}) and the capacitor (e.g., shown as capacitor Cₚᵤₗₛₑ in FIG. 6) is charged, the back-surge of can potentially damage the diode (D₅). This can be more problematic if the capacitor (Cₚᵤₗₛₑ) in the load circuit 514 is fully-charged and the capacitor (C_{dvdt}) is fully-discharged. In this scenario, if the load circuit 514 is reconnected to the power supply 501 before the capacitor (Cₚᵤₗₛₑ) is fully-discharged, the back-surge of current from the load 535 can cause permanent damage to the diode, e.g., if the current surge exceeds the current rating for the diode (D₅). Inclusion of the resistor (R_{dvdt}) of a sufficient resistance value (e.g., sufficient to reduce the surge current through the diode D₅) can help mitigate the above issue, while still allowing the comparator 530 to accurately monitor the rate of change of the output voltage. In this way, the resistor (R_{dvdt}) can assist in reducing the adverse effects of back-surge current and help prevent one or more components (e.g., diode D₅) of the power supply 501 from being damaged.

It should also be noted that the inclusion of the diode (D₅) in the detection-protection circuits 400 and/or 500 serves to prevent high frequency harmonics (e.g., AC harmonic content) from entering the capacitor (C_{dvdt}) of the resistor-capacitor circuit. Such a design can help prevent damage to the resistor-capacitor circuit since such high frequency harmonics can be detrimental to the safety and/or performance of the detection-protection circuit.

FIG. 6 illustrates an example of a load circuit 600, such as a laser treatment system, coupled at an output of a power supply, according to various aspects of the disclosure. For sake of illustration, a complete schematic diagram of the power supply is not shown in FIG. 6. In some examples, block 601 may correspond to any of the power supplies (e.g., power supply 401, power supply 501, etc.) described above with reference to FIGS. 1-5.

In some embodiments, the input end of the power supply may be coupled to an AC source (e.g., AC source 402 in FIG. 4, another applicable current source). Additionally, the output end of the power supply may include a plurality of nodes (or terminals), such as output node 650-a and output node 650-b. Here, the output end of the power supply is coupled to a laser treatment system 666 using a Tx line 653, where the Tx line 653 is used to couple the node 650-a to the node 655-a and the node 650-b to the node 655-b. In some examples, the nodes 655-a and 655-b may serve as the input nodes of the laser treatment system 666.

As seen, the laser treatment system 666 comprises a capacitor (Cₚᵤₗₛₑ) coupled across the input nodes/terminals 655 of the laser treatment system. In some examples, the power supplies (e.g., capacitor chargers) described herein can be used to supply the required voltage and current to charge one or more capacitors, such as those used in laser treatment systems. In this example, the laser treatment system 666 comprises a single capacitor (Cₚᵤₗₛₑ), however, this is not intended to be limiting. For instance, multiple capacitors can be coupled in parallel across the nodes 655-a and 655-b, in which case the total load capacitance is a sum of the individual capacitances of the load capacitors. In either case, the load capacitors, including at least Cₚᵤₗₛₑ, are connected in parallel across a circuit comprising a laser diode (or a laser 669) arranged in series with a semiconductor switch 667 (e.g., MOSFET, IGBT, or another applicable semiconductor switch). As noted above, the power supply (601) can be utilized to charge the capacitor (Cₚᵤₗₛₑ) of the laser treatment system 666. During operation (e.g., medical procedure, such as, tattoo or hair removal), Cₚᵤₗₛₑ can be discharged by closing the switch 667 arranged in series with the laser 669.

This results in a powerful pulse of light from the laser 669, which can then be focused on a target area of the patient.

In one non-limiting example, the power supply (or capacitor charger) may comprise a 1.5 kJ/s 1 kV capacitor charger. However, capacitor chargers having different power and voltage ratings are also contemplated in different embodiments. For example, based on use case, capacitor chargers having a power-voltage rating of 2.5 kJ/s-1 kV or 4 kJ/s-1 kV can also be utilized in some embodiments. In yet other cases, capacitor chargers having a higher voltage rating than 1 kV (e.g., >2 kV) can also be utilized.

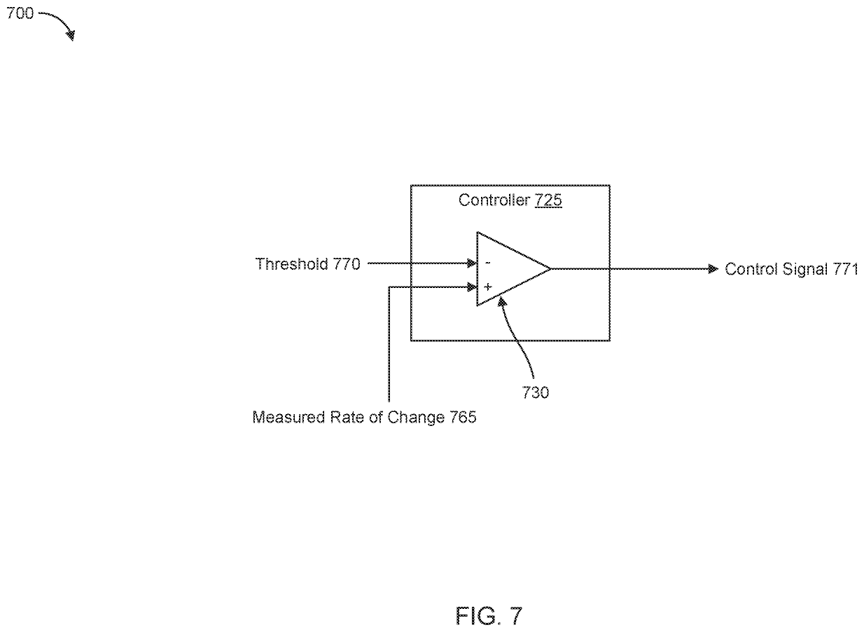

FIG. 7 illustrates an example (700) of a controller 725 comprising a comparator 730, where the controller 725 can be implemented in any of the power supplies described with reference to FIGS. 1 through 6, according to various aspects of the disclosure. As seen, the comparator 730 is configured to receive an indication of a trip-level or threshold 770 (also shown as threshold(s) 170, 270, 370, 470, and/or 570) at one of its input terminals.

Furthermore, the comparator 730 is configured to receive an indication of a measured/monitored rate of change 765 of the output voltage of the power supply at another one of its input terminals. In some cases, one or more of the threshold 770 and the measured rate of change 765 may be received by an input component (e.g., input component 1031 in FIG. 10) of a computing system (e.g., computing system 1000), where the computing system 1000 can be used to effectuate one or more aspects of the present disclosure, as described below. Furthermore, the comparator 730 can compare the measured rate of change 765 of the output voltage (i.e., dv/dt) to the threshold 770 and determine if “dv/dt” exceeds the threshold. If yes, the controller 725 can transmit a control signal 771 to disable the power conversion circuitry (e.g., power conversion circuitry 102 in FIG. 1) or the input source (e.g., AC input power 205 in FIG. 2, input current source 402 in FIG. 4). In other cases, if “dv/dt” does not exceed the threshold, the controller 725 may transmit a control signal to enable the power conversion circuitry or input source, in which case the power supply generates (or continues generating) a voltage across its output terminals. Alternatively, the controller 725 can refrain from transmitting a control signal if “dv/dt” is not exceeded. In some cases, one or more aspects of the controller 725 can be implemented using the computing system 1000 in FIG. 10.

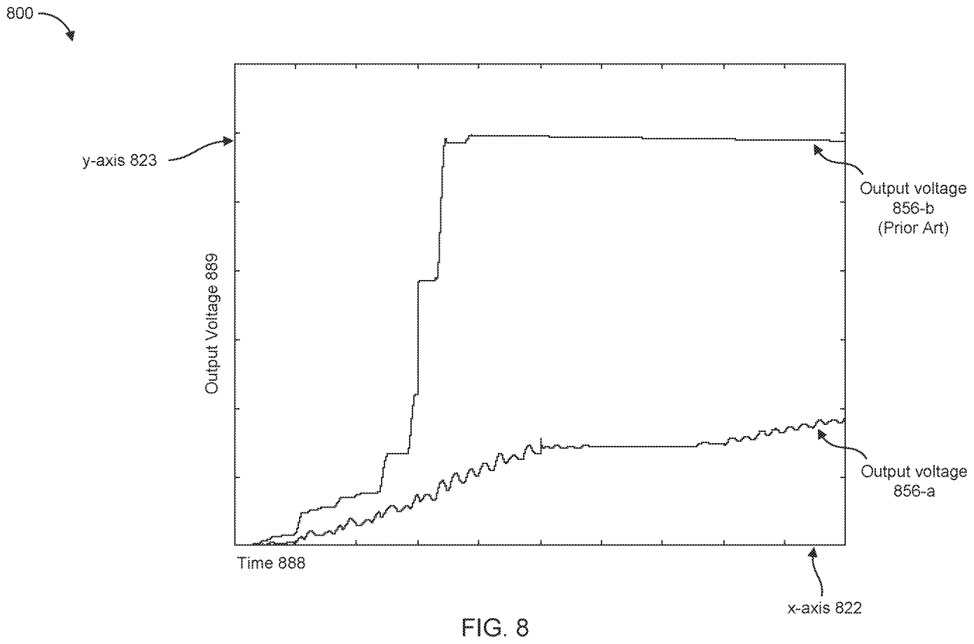

Turning now to FIG. 8, which illustrates a conceptual graph 800 showing a comparison of the output voltage against time for a prior art power supply and the disclosed power supply, according to various aspects of the present disclosure. Here, the output voltage 889 is shown along the vertical or y-axis 823, while time 888 is shown along the horizontal or x-axis 822. It should be noted that both traces 856-a and 856-b depict the output voltage against time during start-up of a power supply (or cap charger) and under open-load conditions. In this example, trace 856-a depicts the output voltage against time for a power supply implementing one or more aspects of the present disclosure. Furthermore, trace 856-b depicts the output voltage against time for a prior art power supply (or cap charger). As seen, under open-load conditions (i.e., open-circuit fault at the output of the power supply), there is a rapid rise in output voltage during start-up of the prior art power supply. In contrast, the high dv/dt protection scheme employed in the disclosed power supply (e.g., power supply 401) helps slow down the rate of change/rise of the output voltage, which allows the overvoltage protection to be fast enough to protect one or more output stage components from damage or stress. Furthermore, slowing down the rate of change of the output voltage (e.g., as seen in trace 856-a) can also assist in reducing the likelihood of false detection of an open-circuit fault.

As seen in the conceptual graph 800 shown in FIG. 8, the output voltage (trace 856-b) of the prior art power supply eventually reaches a steady state value. However, this steady state may be significantly higher than the target or desired output voltage of the power supply. For example, if the desired output voltage is around 1000 V (1 kV), the steady state value of the trace may exceed 2-3 kV, which can result in significant stress or even permanent damage to its internal components (e.g., diodes). Contrastingly, the high dv/dt protection scheme of the present disclosure helps limit the rate at which the output voltage rises, which helps protect the power supply from damage due to over-voltage conditions and allows for sufficient time to verify against false triggers. In some examples, the output voltage (trace 856-a) can even be controlled so that it stays at or below the target or steady state value (e.g., 1 kV).

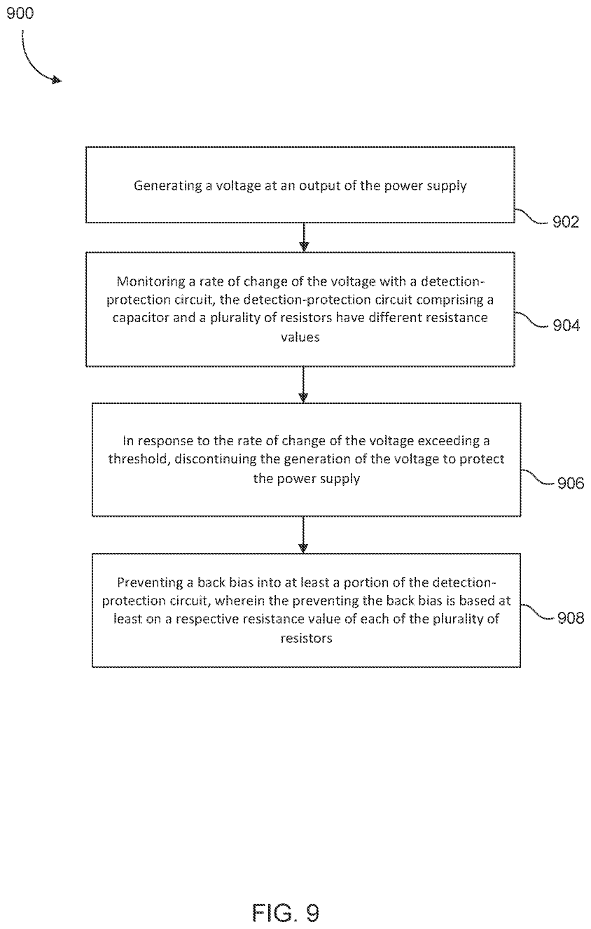

FIG. 9 illustrates an example of a method for protecting a power supply, according to various aspects of the disclosure.

A first operation 902 may comprise generating a voltage at an output of the power supply.

A second operation 904 may comprise monitoring a rate of change of the voltage with a detection-protection circuit (e.g., detection-protection circuit 444 in FIG. 4), the detection-protection circuit comprising a capacitor (C_{dvdt}) and a plurality of resistors having different resistance values. In some cases, the plurality of resistors may include a first resistor (R_{discharge}) and a second resistor (R_{dvdt}), wherein the first resistor and the second resistor have different resistance values.

A third operation 906 may comprise, in response to the rate of change of the voltage exceeding a threshold, discontinuing the generation of the voltage to protect the power supply.

A fourth operation 908 may comprise preventing a back bias into at least a portion of the detection-protection circuit, wherein the preventing the back bias is based at least on a respective resistance value of each of the plurality of resistors.

Thus, as described above, aspects of the present disclosure are directed to a power supply (e.g., capacitor charger) comprising a controller, a comparator, and a detection-protection circuit (e.g., detection-protection circuit 444 in FIG. 4) that can help optimize charging speed of the load capacitor (e.g., Cₚᵤₗₛₑ) and/or minimize overshoot (e.g., with respect to a target load voltage, such as 1 kV), as compared to the prior art. Additionally, the disclosed power supply with its in-built protection system can help protect the internal circuitry (e.g., diodes) of the power supply by discontinuing generation of the output voltage in response to (1) detecting an open-circuit fault, (2) detecting an over-voltage condition, and/or (3) detecting a low or negligible load capacitance. Furthermore, the power supply may be designed to not only protect against open-circuit conditions detected during start-up of the power supply/system, but also protect against open-circuit conditions resulting during operation of the system. The trip-level (or threshold) may also be tunable in some embodiments, which enables the power supply to be used for a variety of use cases. For example, some use cases, such as medical applications, may require the trip level or threshold to be kept fairly low to ensure patient and user safety. In some other cases, the threshold (e.g., threshold 470) provided to the comparator may be selected based on a customer provided specification/requirement. For example, a customer may indicate that the power supply should trip (i.e., discontinue generation of the output voltage) if the load capacitance drops below a certain threshold (i.e., a minimum capacitance, which may be a non-zero capacitance value). In other cases, a customer may indicate that the power supply should only trip when the load capacitance seen by the power supply is zero (i.e., an open-circuit fault). In this way, the power supply can be dynamically tuned to accommodate different customer requirements.

In some examples, the disclosed power supply is also designed to provide surge immunity. In some cases, most (if not all) of the equipment designed for use in the medical sector may need to pass surge testing before they are approved for use. During surge testing, a high energy-high voltage burst of electricity (akin to a lightning strike) is simulated to hit the terminals of the equipment. Besides surviving this simulated “lightning strike”, the equipment also needs to continue operating in order to pass the surge test. Besides surge immunity, the disclosed power supply is also designed to prevent or reduce a back-surge (or back-bias) into at least a portion of the detection-protection circuit (e.g., detection-protection circuit 444 in FIG. 4), which can help minimize or reduce false triggering of the comparator. In some instances, the likelihood of false detection of an open-circuit fault can be reduced by slowing down or reducing the rate of change of the voltage, as previously described with reference to FIG. 8. Additionally, or alternatively, false triggering can be reduced by appropriate selection of resistance values for the resistors (e.g., R_{dvdt}, R_{discharge}) of the protection-detection circuit.

It should be noted that the principles described herein can also be applied to other types of current source power supplies, such as, but not limited to, current transformers and current source IGBT-fed inverters.

Some methods described in connection with the embodiments disclosed herein may be embodied directly in hardware, in processor-executable code encoded in a non-transitory tangible processor readable storage medium, or in a combination of the two. Referring to FIG. 10 for example, shown is a block diagram of a computer system 1000 depicting physical components that may be utilized to realize the controller (e.g., controller 425, controller 725) according to an exemplary embodiment. As shown, in this embodiment a display portion 1012 and nonvolatile memory 1029 are coupled to a bus 1022 that is also coupled to random access memory (“RAM”) 1024, a processing portion (which includes N processing components) 1026, an optional field programmable gate array (FPGA) 1027, and a transceiver component 1028 that includes N transceivers. Although the components depicted in FIG. 10 represent physical components, FIG. 10 is not intended to be a detailed hardware diagram; thus, many of the components depicted in FIG. 10 may be realized by common constructs or distributed among additional physical components. Moreover, it is contemplated that other existing and yet-to-be developed physical components and architectures may be utilized to implement the functional components described with reference to FIG. 10.

This display portion 1012 generally operates to provide a user interface (UI), and in several implementations, the display 1012 may be realized by a touchscreen display. In general, the nonvolatile memory 1029 is non-transitory memory that functions to store (e.g., persistently store) data and processor-executable code (including executable code that is associated with effectuating the methods, such as method 900, described herein). In some embodiments for example, the nonvolatile memory 1029 includes bootloader code, operating system code, file system code, and non-transitory processor-executable code to facilitate the execution of a method described with reference to FIG. 9 described further herein.

In many implementations, the nonvolatile memory 1029 is realized by flash memory (e.g., NAND or ONENAND memory), but it is contemplated that other memory types may be utilized as well. Although it may be possible to execute the code from the nonvolatile memory 1029, the executable code in the nonvolatile memory is typically loaded into RAM 1024 and executed by one or more of the N processing components in the processing portion 1026.

The N processing components in connection with RAM 1024 generally operate to execute the instructions stored in nonvolatile memory 1029 to enable one or more operations described in relation to FIG. 9. For example, non-transitory, processor-executable code to effectuate the method 900 described with reference to FIG. 9 may be persistently stored in nonvolatile memory 1029 and executed by the N processing components in connection with RAM 1024. As one of ordinarily skill in the art will appreciate, the processing portion 1026 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 1026 may be configured to effectuate one or more aspects of the methodologies described herein (e.g., the method 900 described with reference to FIG. 9). For example, non-transitory processor-readable instructions may be stored in the nonvolatile memory 1029 or in RAM 1024 and when executed on the processing portion 1026, cause the processing portion 1026 to perform one or more of the operations described with reference to FIG. 9. Alternatively, non-transitory FPGA-configuration-instructions may be persistently stored in nonvolatile memory 1029 and accessed by the processing portion 1026 (e.g., during boot up) to configure the hardware-configurable portions of the processing portion 1026 to effectuate the functions of any of the system(s) 100, 200, 300, 400, and/or 500 configured for open-circuit and back-surge protection for power supplies (e.g., capacitor chargers).

The input component 1031 operates to receive signals (e.g., trip-level or threshold 770, measured rate of change 765, etc.) that are indicative of one or more aspects of the detection of an open-circuit fault at an output of a power supply. The output component 1032 generally operates to provide one or more analog or digital signals to effectuate an operational aspect of an open-circuit and back-surge protection system for power supplies, to name one non-limiting example. For example, the output component 1032 may provide the control signal 771 for enabling or disabling the generation of the voltage at the output of the power supply, as described with reference to FIG. 7.

The depicted transceiver component 1028 includes N transceiver chains, which may be used for communicating with external devices via wireless or wireline networks. Each of the N transceiver chains may represent a transceiver associated with a particular communication scheme (e.g., Wi-Fi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like may refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform or system (e.g., computer system 1000).

As will be appreciated by one skilled in the art, aspects of the present disclosure may be embodied as a system, method, apparatus, a controller, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (e.g., rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups but do not preclude the presence or addition of one or more other features, integers, steps, operations, elements, components, and/or groups thereof. As used herein, the term “and/or” includes any and all combinations of one or more of the associated listed items and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

What is claimed is:

1. A method for protecting a power supply, comprising:
generating a voltage at an output of the power supply;
monitoring a rate of change of the voltage with a detection-protection circuit, the detection-protection circuit comprising a capacitor and a plurality of resistors having different resistance values;
in response to the rate of change of the voltage exceeding a threshold, discontinuing the generation of the voltage to protect the power supply; and
preventing a back bias into at least a portion of the detection-protection circuit, wherein the preventing the back bias is based at least on a respective resistance value of each of the plurality of resistors.

2. The method of claim 1, wherein the detection-protection circuit comprises:
a resistor-capacitor circuit having the capacitor and a first resistor arranged in series;
a diode; and
a second resistor, wherein the first resistor has a higher resistance value than the second resistor; and
wherein the method further comprises:
preventing damage to the resistor-capacitor circuit, based in part on the diode preventing high frequency harmonics from entering the capacitor of the resistor-capacitor circuit.

3. The method of claim 2, wherein the higher resistance value of the first resistor as compared to the second resistor enables:
reducing an amount of current flowing through the capacitor of the resistor-capacitor circuit; and
limiting the voltage at the output of the power supply during an open-circuit fault, based at least in part on the reducing the amount of current flowing through the capacitor.

4. The method of claim 2, wherein the method further comprises:
providing a current path through the capacitor and a diode of the detection-protection circuit for one or more of limiting the voltage during an open-circuit fault and reducing the rate of change of the voltage; and
discharging the capacitor through the first resistor.

5. The method of claim 2, wherein one or more of:
a resistance value of the first resistor is at least 500 times greater than a resistance value of the second resistor; and
the power supply comprises a capacitor charger.

6. The method of claim 1, wherein the generating the voltage at the output of the power supply further comprises:
applying an alternating current (AC) waveform at an input of the power supply; and
rectifying the AC waveform to produce a rectified direct current (DC) waveform with an AC component at the output of the power supply.

7. The method of claim 1, wherein the generating the voltage at the output of the power supply further comprises applying a direct current (DC) waveform at an input of the power supply.

8. The method of claim 1, wherein the method further comprises:
minimizing or reducing a false detection of an open-circuit fault at the output of the power supply by slowing down or reducing the rate of change of the voltage.

9. The method of claim 1, wherein discontinuing the generation of the voltage is based at least in part on detecting an open-circuit fault at the output of the power supply.

10. A power supply comprising:
an input end configured for coupling to a power source;
a plurality of output terminals configured for coupling to a load;
a detection-protection circuit comprising:
a resistor-capacitor circuit having a capacitor and a first resistor, and
a back bias prevention circuit having at least a second resistor, wherein the back bias prevention circuit is configured to prevent a back bias into the capacitor of the resistor-capacitor circuit based at least in part on the first and second resistors having different resistance values; and
one or more processing devices configured to:
monitor a voltage across the plurality of output terminals using the detection-protection circuit; and
disable the power source responsive to the monitored voltage reaching a threshold.

11. The power supply of claim 10, wherein,
the resistor-capacitor circuit comprises the capacitor arranged in series with the first resistor; and
the back bias prevention circuit further comprises a diode, wherein a first end of the diode is coupled between the capacitor and the first resistor, and wherein a second end of the diode is coupled to a first end of the second resistor and a comparator.

12. The power supply of claim 11, wherein the comparator is configured to compare a rate of change of the monitored voltage to a trip level or the threshold.

13. The power supply of claim 11, wherein the first resistor has a higher resistance value than the second resistor, thereby,
reducing an amount of current flowing through the resistor-capacitor circuit; and
limiting a voltage across the output terminals of the power supply during an open-circuit fault.

14. The power supply of claim 13, further comprising a path for current to flow from the capacitor, and through the diode and the second resistor for one or more of:
limiting the voltage across the output terminals of the power supply during the open-circuit fault; and
reducing the rate of change of the voltage.

15. The power supply of claim 10, wherein the back bias prevention circuit is configured to minimize or reduce a likelihood of a false detection of an open-circuit fault across the output terminals of the power supply by slowing down or reducing the rate of change of the voltage.

16. The power supply of claim 10, wherein disabling the power source is based at least in part on detecting an open-circuit fault across the output terminals of the power supply.

17. The power supply of claim 10, further comprising:
a rectifier circuit coupled to the input end and configured to receive an alternating current (AC) waveform from the power source and provide a rectified direct current (DC) waveform with an AC component at the output terminals of the power supply.

18. The power supply of claim 10, wherein the power source comprises a direct current (DC) power source.

19. An open-circuit and back-surge protection system for power supplies, comprising:
a detection-protection circuit, the detection-protection circuit coupled between an input end and an output end of a power supply, the detection-protection circuit comprising:
a resistor-capacitor circuit having a capacitor and a first resistor arranged in series; and
a back bias prevention circuit having at least a second resistor, wherein the back bias prevention circuit is configured to prevent a back bias into the capacitor of the resistor-capacitor circuit, based at least in part on the first and second resistors having different resistance values; and
one or more processing devices configured to:
monitor, using the detection-protection circuit, a rate of change of a voltage at the output end of the power supply; and
in response to the rate of change of the voltage exceeding a threshold, discontinue the generation of the voltage to protect the power supply.

20. The open-circuit and back-surge protection system of claim 19, wherein:
the back bias prevention circuit further comprises a diode, wherein a first end of the diode is coupled between the capacitor and the first resistor, and wherein a second end of the diode is coupled to a first end of the second resistor and a comparator; and
a resistance value of the first resistor is at least 500 times greater than a resistance value of the second resistor.
